(19) United States
(12) Patent Application Publication
(10) Pub. No.: US 2010/0285176 A1
(43) Pub. Date: Nov. 11, 2010

(54) FERMENTATION PRODUCT OF ALOE, METHOD OF MANUFACTURING THE SAME AND FUNCTIONAL FOODS USING THE SAME

(76) Inventors: Soon Ok Baek, Chungcheongbuk-do (KR); Bong Gyoon Kim, Chungcheongbuk-do (KR); Ju Hyun Cho, Chungcheongbuk-do (KR)

Correspondence Address: JENKINS, WILSON, TAYLOR & HUNT, P. A., 3100 Tower Blvd., Suite 1200, DURHAM, NC, 27707, US

(21) Appl. No.: 12/763,804

(22) Filed: Apr. 20, 2010

Related U.S. Application Data
(63) Continuation of application No. PCT/KR2009/002458, filed on May 11, 2009.

(51) Int. Cl. A23L 1/212

(52) U.S. Cl. 426/49; 426/615

(57) ABSTRACT

There are provided a fermentation product of aloe, a method of manufacturing the same and functional foods using the same. More particularly, the present invention relates to a method of manufacturing a fermentation product of aloe by culturing mushroom mycelia in an aloe natural medium containing many effective ingredients and thus having diverse bioactive effects, and a method of manufacturing functional foods having various pharmacological effects of improving stomach function, enhancing immunity and having effectiveness against cancer by using the fermentation product of aloe.

The method of a fermentation product of aloe comprises the steps of: preparing an aloe natural medium by obtaining a viscous gel by processing fresh aloe leaves through the steps of collection-cleaning-peeling-pulverization, heating/sterilizing only the viscous gel or a mixture of the viscous gel and purified water placed in a fermentation culture tank, and quenching the heated viscous gel or mixture; preparing mushroom spores to be cultured in the aloe natural medium; inoculating the mushroom spores into the aloe natural medium; and culturing/fermenting the aloe natural medium inoculated with the mushroom spores.

The fermentation product of aloe manufactured by the aforementioned method is processed to be directly used or to be added to diverse foods.

### TECHNICAL FIELD

The present invention relates to a fermentation product of aloe, a method of manufacturing the same and functional foods using the same. More particularly, the present invention relates to a method of manufacturing a fermentation product of aloe by culturing mushroom mycelia in an aloe natural medium containing many effective ingredients and thus having diverse bioactive effects, and a method of manufacturing functional foods having various pharmacological effects of improving stomach function, enhancing immunity and having effectiveness against cancer by using the fermentation product of aloe.

### BACKGROUND ART

In general, aloe is a perennial plant which belongs to the lily family and aloe genus in botanical terms. Aloe is considered a top favorite plant which has been used in folk remedies and Chinese medicines for about 4,000 years.

Among the many kinds of aloes, three or four kinds, such as aloe vera, aloe arborescens and saponaria, are directly edible and used for fresh juice. The major aloe ingredients include high molecular weight polysaccharides, alomichin, aloin, aloetic acid and aloe ulcin, among others. These ingredients have the effects of lowering high blood pressure, tumor prevention, strengthening the stomach, functioning in intestinal regulation and cell regeneration.

As a study of aloe fermentation, Korean Patent Registration No. 0128714 discloses a lactobacillus mutant having high acid productivity and a method of manufacturing a fermented green tea drink using the same.

In Korean Patent Registration No. 0128714, a fermented aloe vera drink is produced by adding lactobacillus to aloe vera for fermentation. Specifically, an aloe vera gel is fermented by using lactobacillus having high lactic acid productivity and a nice flavor. This patent is characterized by providing the aloe vera gel to greatly improve its taste and preference by lactobacillus fermentation, without adding any organic acid or flavor.

The technique disclosed in the aforementioned patent relates to a method of manufacturing a fermented aloe vera drink, the method comprising the steps of obtaining a viscous gel from aloe by cleaning fresh aloe leaves and peeling the aloe leaves, adding a vitamin and a viscosity increasing agent to the gel, adding sugar, fructose and glucose (10 brix) thereto, adjusting the pH by using sodium carbonate or sodium bicarbonate, and culturing lactobacillus to recovering a fermentation product of aloe vera.

In addition to the aforementioned method, there is a method of fermenting aloe with a sweet. Since such fermentation is made many times, the use of the fermentation product of aloe obtained by fermentation is limited.

Further, general aloes are directly or indirectly taken as materials for functional health foods. However, the undesirable taste of aloe is raised as the biggest problem upon direct ingestion. The viscous gel properties of aloe are raised as a problem in storing aloe.

### DISCLOSURE

### Technical Problem

Therefore, the present invention has been made to solve the above problems, and it is an aspect of the present invention to provide a fermentation product of aloe from which the strong undesirable taste of aloe is completely removed and which can be stored for a long time, by fermenting mushroom spores, using aloe as a natural medium.

It is also another aspect of the present invention to obtain a fermentation product of aloe having no undesirable taste or odor, by culturing mushroom spores, without adding any materials, such as sugar or acid, to a viscous gel of aloe, and to provide a variety of functional products having diverse pharmacological effects, by using the fermentation product of aloe.

Specifically, it is another aspect of the present invention to provide a fermentation product of aloe including various effective ingredients of Ganoderma lucidum which has many bioactive effects, such as immunity enhancement, anti-cancer, anti-oxidation and stomach function improvement, among others, when taking the fermentation product of aloe, by including the various effective ingredients of Ganoderma lucidum in the fermentation product of aloe.

### Technical Solution

An aloe natural medium is prepared by using aloe.

Any one selected from a group consisting of Ganoderma lucidum, Phellinus linteus, Cordyceps militaris, Paecilomyces japonica, Hericium erinaceum and Agaricus blazei is cultured at a temperature 24˜34° C., at a ventilation rate of 0.3˜0.8 vvm, for 4˜8 days, to prepare mushroom spores.

The mushroom spores are inoculated into an aloe natural medium at 5˜15% (w/w).

The aloe natural medium inoculated with the mushroom spores is cultured and fermented at a temperature of 24˜34° C., for 3˜10 days, to produce a fermentation product of aloe.

The fermentation product of aloe may be further matured at a low temperature of 3˜10° C., for 1˜3 days.

For preparing the aloe natural medium, fresh aloe leaves or dried aloe is used.

In the case of using fresh aloe leaves, the aloe leaves are processed to produce a viscous gel and the viscous gel is placed into a fermentation culture tank and heated to be sterilized. The sterilized viscous gel is then quenched to room temperature, thereby preparing the aloe natural medium. More specifically, the viscous gel is obtained by processing the aloe leaves by the steps of collection-cleaning-peeling-pulverization, only the obtained viscous gel or a mixture of the viscous gel of 25˜99 wt % and purified water of 1˜75 wt % is placed into the fermentation culture tank, heated at 113˜125° C. for 2˜30 minutes for the sterilization process, and cooled (quenched) to 20˜25° C.

In the case of using dried aloe, a mixture of the dried aloe of 0.5˜7.0 wt % and purified water of 93.0˜99.5 wt % is placed into the fermentation culture tank, mixed, heated at 113˜125° C. for 2˜30 minutes for the sterilization process, and cooled (quenched) to 20˜25° C., to prepare the aloe natural medium.

Generally, the viscous gel from the dried aloe is obtained by processing aloe leaves by the steps of collection-cleaning-peeling-pulverization. The obtained viscous gel is prepared by freeze-drying or hot air drying.

The fermentation product of aloe prepared by the aforementioned method is processed so that only it is directly taken, or it is used to be added to various foods. That is, the fermentation product of aloe is manufactured for direct intake or it is freeze-dried for use as a food material.

The fermentation product of aloe is used to manufacture foods having many bioactive effects, such as immunity enhancement, anti-cancer, anti-oxidation and stomach function improvement, among others.

The fermentation product of aloe is used as a main material for a drink having many bioactive effects.

In accordance with the present invention, the above and other aspects can be accomplished by a method of manufacturing a fermentation product of aloe, the method comprising: a preparation step S1 of making an aloe natural medium, a mushroom spore preparation step S2 of preparing mushroom spores to be cultured in the aloe natural medium, an inoculation step S3 of inoculating the mushroom spores into the aloe natural medium, a culture/fermentation step S4 of culturing and fermenting the aloe natural medium inoculated with the mushroom spores, and a recovering step S5 of recovering a fermentation product of aloe. The method may further comprise a maturing step S6 of maturing the fermentation product of aloe recovered in the recovering step S5.

In the preparation step S1 to use aloe as a natural medium, fresh aloe leaves or dried aloe is used.

The aloe natural medium prepared by using fresh aloe leaves is made by obtaining a viscous gel by processing the aloe leaves by the steps of collection-cleaning-peeling-pulverization, placing only the viscous gel or a mixture of the viscous gel of 25˜99 wt % and purified water of 1˜75 wt % into a fermentation culture tank to be heated at 113˜125° C. for 2˜30 minutes for sterilization, and cooling (quenching) the heated viscous gel or mixture to room temperature (20˜25° C.). This natural medium uses 100% pure aloe, unlike the other methods of fermenting aloe by adding other materials, such as sugar.

The aloe natural medium prepared by using dried aloe is made by obtaining a viscous gel by processing aloe leaves by the steps of collection-cleaning-peeling-pulverization, drying the obtained viscous gel by freeze-drying or hot air drying to prepare the dried aloe, making a mixture of the dried aloe of 0.5˜7.0 wt % and purified water of 93.0˜99.5 wt %, placing the mixture into a fermentation culture tank and mixing the mixture, heating the mixture at 113˜125° C. for 2˜30 minutes to be sterilized, and cooling (quenching) the heated mixture to 20˜25° C.

In the mushroom spore preparation step S2, the mushroom spores are cultured at the optimum conditions, to be used as the mushroom spores for the present invention. The mushroom spores are cultured at 24˜34° C. and at a ventilation rate of 0.3˜0.8 vvm, for 4˜8 days. To be used as mushroom spores, only one kind is selected from a group consisting of Ganoderma lucidum, Phellinus linteus, Cordyceps militaris, Paecilomyces japonica, Hericium erinaceum and Agaricus blazei.

In the inoculation step S3 of inoculating the mushroom spores, the mushroom pre-culture fluid (spores) already cultured in the mushroom spore preparation step S2 is inoculated into the culture tank containing the aloe natural medium prepared in the preparation step S1. The mushroom spores are inoculated into the aloe natural medium at 5˜15% (w/w).

In the culture/fermentation step S4, the aloe natural medium inoculated with the mushroom pre-culture fluid (spores) are cultured and fermented at the optimum conditions (temperature: 24˜32° C. and ventilation rate: 0.4˜0.8 vvm) for 3˜10 days.

According to the kind of the mushroom pre-culture fluid (spores) cultured in the culture tank containing the 100% aloe natural medium, the temperature and period in the preparation step S2 are slightly different.

Specifically, after Ganoderma lucidum spores are inoculated, it is appropriate to culture the spores at the optimal culture temperature of 29˜30° C. and ventilation rate of 0.3˜0.5 vvm. After Cordceps militaris spores are inoculated, it is appropriate to culture the spores at the optimal culture temperature of 25° C. and ventilation rate of 0.3˜0.5 vvm. After Phellinus linteus spores are inoculated, it is appropriate to culture the spores at the optimal culture temperature of 30° C. and ventilation rate of 0.4˜0.6 vvm. After Hericium erinaceum spores are inoculated, it is appropriate to culture the spores at the optimal culture temperature of 25° C. and ventilation rate of 0.4˜0.6 vvm.

As described above, when inoculating the medicinal mushroom spores into the aloe natural medium, the temperature and ventilation conditions vary according to the properties of the respective mushroom spores and the culture extent. However, generally, the mushroom spores cultured in the culture tank are adjustably prepared under the conditions that the temperature is 24˜34° C. and the ventilation rate is 0.3˜0.8 vvm and within the culture period of 4˜8 days.

The maturing step S6 may be added, depending on a method of manufacturing a final product using the fermentation product of aloe recovered in the recovering step S5. The fermentation product of aloe is matured at a low temperature of 3˜10° C. for 1˜3 days.

The fermentation product of aloe manufactured according to the above-described method can be used for manufacturing foods to directly and indirectly use the fermentation product of aloe. Examples of a method of manufacturing functional foods using the fermentation product of aloe will be described below:

First, there is provided a method of manufacturing functional foods enabling direct ingestion of the fermentation product of aloe. In this method, the fermentation product of aloe as recovered is packaged as a final product to be directly ingested.

Second, there is provided a method of manufacturing functional foods, by using the fermentation product of aloe which is freeze-dried as the functional food material. In this method, the freeze-dried fermentation product of aloe is added to the functional foods, thereby enabling indirect intake of the fermentation product of aloe as recovered.

Third, there is provided a method of manufacturing an aloe drink as functional foods, by using the fermentation product of aloe as a main material of the drink.

That is, the fermentation product of aloe manufactured according to the above-described method can be provided as a final product, by processing the fermentation product of aloe into the form of a drink, a capsule or a tablet.

### ADVANTAGEOUS EFFECTS

As described above, the fermentation product of aloe is manufactured by fermenting the mushroom spores in the natural medium using aloe. Therefore, since the undesirable taste of aloe is completely removed, it is possible to directly take the fermentation product of aloe. Further, since people can easily ingest the fermentation product of aloe without any unpleasant feeling, it can be developed as various products.

Furthermore, since aloe is manufactured as the fermentation product of aloe, it can be stored for a long time and thus its use is increased.

Specifically, in the fermentation product of aloe manufactured according to the present invention, not only its taste is improved but also it can be directly/indirectly ingested. Therefore, the fermentation product of aloe having many bioactive effects, such as anti-oxidation, immunity enhancement, and the like, which are the original effects of the various mushroom spores including Ganoderma lucidum used in the fermentation product of aloe, can be developed for use in many functional foods.

### DESCRIPTION OF DRAWINGS

These and other aspects and advantages of the present invention will become apparent and more readily appreciated from the following description of the embodiments, taken in conjunction with the accompanying drawings, in which:

FIG. 1 is a flow chart illustrating a method of manufacturing a fermentation product of aloe according to a preferred exemplary embodiment of the present invention;

FIG. 2 is a fermentation product of Ganoderma lucidum fermented in an aloe natural medium prepared by using fresh aloe leaves according to another exemplary embodiment of the present invention;

FIG. 3 is a fermentation product of Phellinus linteus fermented in the aloe natural medium prepared by using fresh aloe leaves according to another exemplary embodiment of the present invention;

FIG. 4 is a fermentation product of Cordyceps militaris fermented in the aloe natural medium prepared by using fresh aloe leaves according to another exemplary embodiment of the present invention; and

FIG. 5 is a fermentation product of Ganoderma lucidum fermented in an aloe natural medium prepared by using dried aloe according to another exemplary embodiment of the present invention.

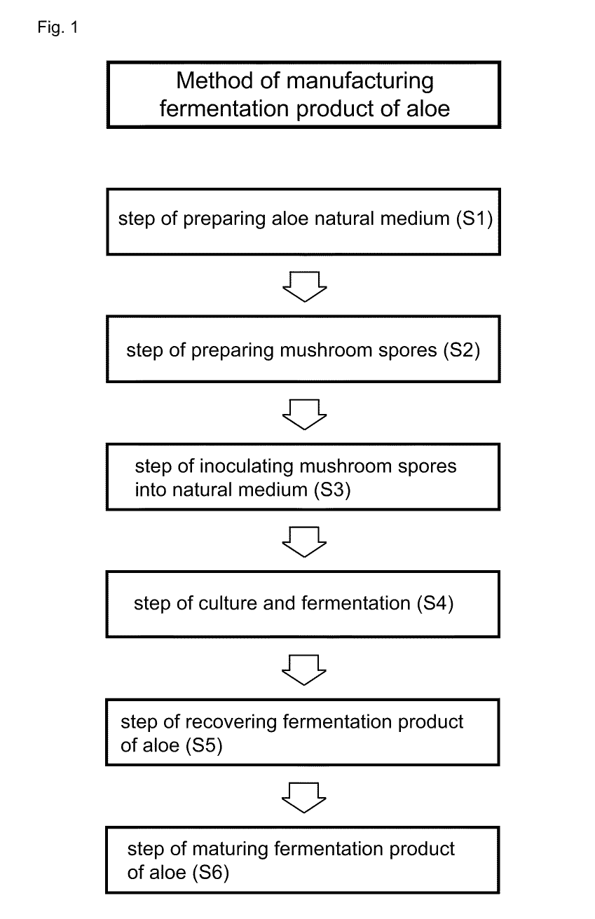

### BEST MODE

### Mode for Invention

Hereinafter, embodiments of the present invention will be described in detail with reference to the accompanying drawings.

### Exemplary Embodiment 1

A method of manufacturing a fermentation product of aloe by using Ganoderma lucidum as spores (pre-culture fluid), the method comprises:

\textcircled{1} step S1 of preparing an aloe natural medium using fresh aloe leaves: The 100% aloe natural medium is prepared by obtaining a viscous gel by processing the aloe leaves through the steps of collection-cleaning-peeling-pulverization, placing the gel into a fermentation culture tank, sterilizing the gel at 120° C. for 20 minutes, and cooling (quenching) the gel to 25° C.

\textcircled{2} step S2 of preparing Ganoderma lucidum spores: To use Ganoderma lucidum fungi as the spores (pre-culture fluid), the spores (pre-culture fluid) are prepared by culturing the Ganoderma lucidum fungi at a temperature of 30° C. and a shaking rate of 120 rpm, for 4 days.

\textcircled{3} step S3 of inoculating the Ganoderma lucidum spores: The Ganoderma lucidum pre-culture fluid (spores) prepared in the step S2 are inoculated into the aloe natural medium prepared in step S1, at 8% (w/w).

\textcircled{4} step S4 of culturing and fermenting the aloe natural medium inoculated with the Ganoderma lucidum spores: The aloe natural medium inoculated with the Ganoderma lucidum spores in step S3 is cultured and fermented at the optimum conditions (at a temperature of 30° C. and a shaking rate 120 rpm) for 8 days.

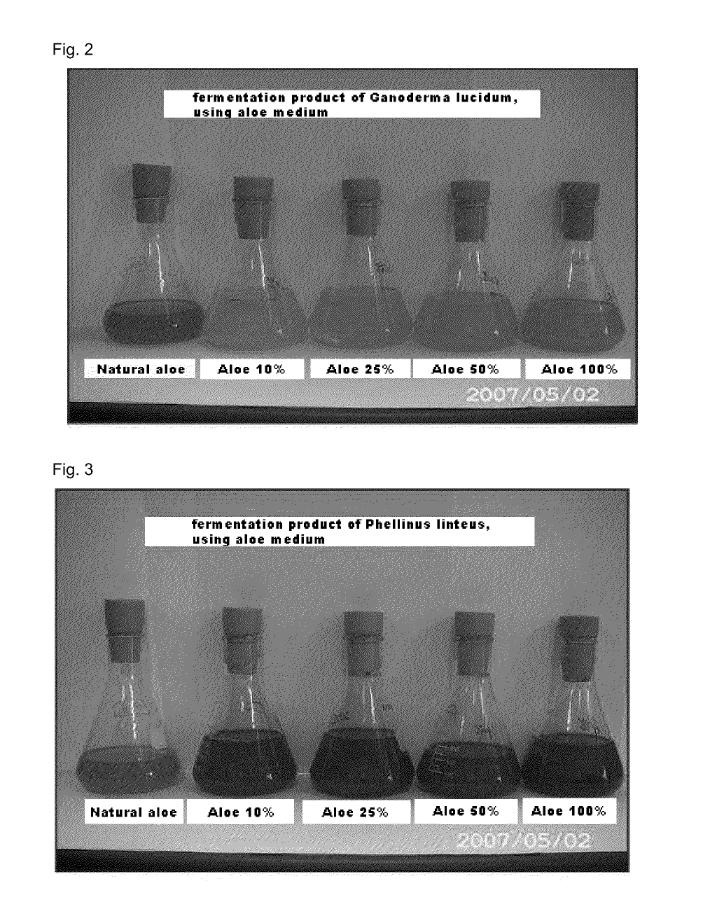

\textcircled{5} step S5 of recovering a fermentation product of aloe: The fermentation product of aloe, the culture of which is completed in step S4, is recovered as shown in FIG. 2.

### Exemplary Embodiment 2

A method of manufacturing a fermentation product of aloe by using Phellinus linteus as spores (pre-culture fluid), the method comprises:

\textcircled{1} step S1 of preparing an aloe natural medium using fresh aloe leaves: The 100% aloe natural medium is prepared by obtaining a viscous gel by processing the aloe leaves through the steps of collection-cleaning-peeling-pulverization, placing the gel into a fermentation culture tank, sterilizing the gel at 120° C. for 20 minutes, and cooling (quenching) the gel to 25° C.

\textcircled{2} step S2 of preparing Phellinus linteus spores: To use Phellinus linteus fungi as the spores (pre-culture fluid), the spores (pre-culture fluid) are prepared by culturing the Phellinus linteus fungi at a temperature of 29° C. and a shaking rate of 125 rpm, for 5 days.

\textcircled{3} step S3 of inoculating the Phellinus linteus spores: The Phellinus linteus pre-culture fluid (spores) prepared in step S2 are inoculated into the aloe natural medium prepared in step S1, at 7% (w/w).

\textcircled{4} step S4 of culturing and fermenting the aloe natural medium inoculated with the Phellinus linteus spores: The aloe natural medium inoculated with the Phellinus linteus spores in step S3 is cultured and fermented at the optimum conditions (at a temperature of 29° C. and a shaking rate 125 rpm) for 8 days.

\textcircled{5} step S5 of recovering a fermentation product of aloe: The fermentation product of aloe, the culture of which is completed in step S4, is recovered as shown in FIG. 3.

### Exemplary Embodiment 3

A method of manufacturing a fermentation product of aloe by using Cordyceps militaris as spores (pre-culture fluid), the method comprises:

\textcircled{1} step S1 of preparing an aloe natural medium using fresh aloe leaves: The 100% aloe natural medium is prepared by obtaining a viscous gel by processing the aloe leaves through the steps of collection-cleaning-peeling-pulverization, placing the gel into a fermentation culture tank, sterilizing the gel at 120° C. for 20 minutes, and cooling (quenching) the gel to 25° C.

\textcircled{2} step S2 of preparing Cordyceps militaris spores: To use Cordyceps militaris fungi as the spores (pre-culture fluid), the spores (pre-culture fluid) are prepared by culturing the Cordyceps militaris fungi at a temperature of 25° C. and a shaking rate of 115 rpm, for 6 days.

\textcircled{3} step S3 of inoculating the Cordyceps militaris spores: The Cordyceps militaris pre-culture fluid (spores) prepared in step S2 are inoculated into the aloe natural medium prepared in step S1, at 8% (w/w).

\textcircled{4} step S4 of culturing and fermenting the aloe natural medium inoculated with the Cordyceps militaris spores: The aloe natural medium inoculated with the Cordyceps militaris spores in step S3 is cultured and fermented at the optimum conditions (at a temperature of 25° C. and a shaking rate 115 rpm) for 8 days.

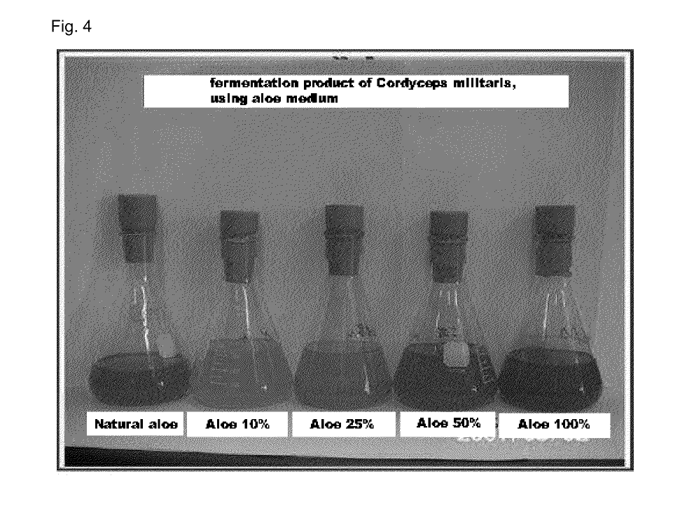

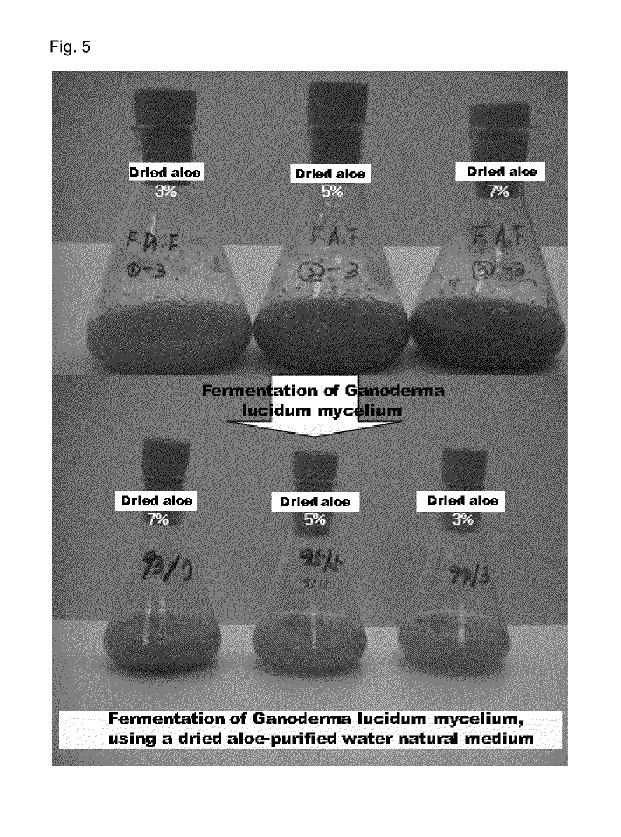

\textcircled{5} step S5 of recovering a fermentation product of aloe: The fermentation product of aloe, the culture of which is completed in step S4, is recovered as shown in FIG. 4.

### Exemplary Embodiment 4

A method of manufacturing a fermentation product of aloe by using Hericeum erinaceum as spores (pre-culture fluid), the method comprises:

\textcircled{1} step S1 of preparing an aloe natural medium using fresh aloe leaves: The 100% aloe natural medium is prepared by obtaining a viscous gel by processing the aloe leaves through the steps of collection-cleaning-peeling-pulverization, placing the gel into a fermentation culture tank, sterilizing the gel at 120° C. for 20 minutes, and cooling (quenching) the gel to 25° C.

\textcircled{2} step S2 of preparing Hericeum erinaceum spores: To use Hericeum erinaceum fungi as the spores (pre-culture fluid), the spores (pre-culture fluid) are prepared by culturing the Hericeum erinaceum fungi at a temperature of 25° C. and a shaking rate of 125 rpm, for 5 days.

\textcircled{3} step S3 of inoculating the Hericeum erinaceum spores: The Hericeum erinaceum pre-culture fluid (spores) prepared in step S2 are inoculated into the aloe natural medium prepared in step S1, at 8% (w/w).

\textcircled{4} step S4 of culturing and fermenting the aloe natural medium inoculated with the Hericeum erinaceum spores: The aloe natural medium inoculated with the Hericeum erinaceum spores in step S3 is cultured and fermented at the optimum conditions (at a temperature of 25° C. and a shaking rate 125 rpm) for 8 days.

\textcircled{5} step S5 of recovering a fermentation product of aloe: The fermentation product of aloe, the culture of which is completed in step S4, is recovered.

### Exemplary Embodiment 5

A method of manufacturing a fermentation product of aloe by using Ganoderma lucidum as spores (pre-culture fluid), the method comprises:

\textcircled{1} step S1 of preparing an aloe natural medium using dried aloe: This step is to prepare the natural medium by mixing the dried aloe and purified water. The pure aloe natural medium is prepared by placing a mixture of 3% dried aloe and 97% purified water, another mixture of 5% dried aloe and 95% purified water, and another mixture of 7% dried aloe and 93% purified water into fermentation culture tanks, respectively, mixing the mixtures, applying heat to the mixtures to be sterilized at 113˜125° C. for 2˜30 minutes, and cooling (quenching) the mixtures to 20˜25° C.

\textcircled{2} step S2 of preparing Ganoderma lucidum spores: To use Ganoderma lucidum fungi as the spores (pre-culture fluid), the spores (pre-culture fluid) are prepared by culturing the Ganoderma lucidum fungi at a temperature of 30° C. and a shaking rate of 120 rpm, for 4 days.

\textcircled{3} step S3 of inoculating the Ganoderma lucidum spores: The Ganoderma lucidum pre-culture fluid (spores) prepared in step S2 are inoculated into the aloe natural medium prepared in step S1, at 8% (w/w).

\textcircled{4} step S4 of culturing and fermenting the aloe natural medium inoculated with the Ganoderma lucidum spores: The aloe natural medium inoculated with the Ganoderma lucidum spores in step S3 is cultured and fermented at the optimum conditions (at a temperature of 30° C. and a shaking rate 120 rpm) for 8 days.

\textcircled{5} step S5 of recovering a fermentation product of aloe: The fermentation product of aloe, the culture of which is completed in step S4, is recovered as shown in FIG. 2.

### Exemplary Embodiment 6

A method of manufacturing a fermentation product of aloe by using Phellinus linteus as spores (pre-culture fluid), the method comprises:

\textcircled{1} step S1 of preparing an aloe natural medium using dried aloe: This step is to prepare the natural medium by mixing the dried aloe and purified water. The pure aloe natural medium is prepared by placing a mixture of 3% dried aloe and 97% purified water, another mixture of 5% dried aloe and 95% purified water, and another mixture of 7% dried aloe and 93% purified water into fermentation culture tanks, respectively, mixing the mixtures, applying heat to the mixtures to be sterilized at 113˜125° C. for 2˜30 minutes, and cooling (quenching) the mixtures to 20˜25° C.

\textcircled{2} step S2 of preparing Phellinus linteus spores: To use Phellinus linteus fungi as the spores (pre-culture fluid), the spores (pre-culture fluid) are prepared by culturing the Phellinus linteus fungi at a temperature of 29° C. and a shaking rate of 125 rpm, for 5 days.

\textcircled{3} step S3 of inoculating the Phellinus linteus spores: The Phellinus linteus pre-culture fluid (spores) prepared in step S2 are inoculated into the aloe natural medium prepared in step S1, at 7% (w/w).

\textcircled{4} step S4 of culturing and fermenting the aloe natural medium inoculated with the Phellinus linteus spores: The aloe natural medium inoculated with the Phellinus linteus spores in step S3 is cultured and fermented at the optimum conditions (at a temperature of 29° C. and a shaking rate 125 rpm) for 8 days.

\textcircled{5} step S5 of recovering a fermentation product of aloe: The fermentation product of aloe, the culture of which is completed in step S4, is recovered as shown in FIG. 3.

### Exemplary Embodiment 7

A method of manufacturing a fermentation product of aloe by using Cordyceps militaris as spores (pre-culture fluid), the method comprises:

\textcircled{1} step S1 of preparing an aloe natural medium using dried aloe: This step is to prepare the natural medium by mixing the dried aloe and purified water. The pure aloe natural medium is prepared by placing a mixture of 3% dried aloe and 97% purified water, another mixture of 5% dried aloe and 95% purified water, and another mixture of 7% dried aloe and 93% purified water into fermentation culture tanks, respectively, mixing the mixtures, applying heat to the mixtures to be sterilized at 113˜125° C. for 2˜30 minutes, and cooling (quenching) the mixtures to 20˜25° C.

\textcircled{2} step S2 of preparing Cordyceps militaris spores: To use Cordyceps militaris fungi as the spores (pre-culture fluid), the spores (pre-culture fluid) are prepared by culturing the Cordyceps militaris fungi at a temperature of 25° C. and a shaking rate of 115 rpm, for 6 days.

\textcircled{3} step S3 of inoculating the Cordyceps militaris spores: The Cordyceps militaris pre-culture fluid (spores) prepared in step S2 are inoculated into the aloe natural medium prepared in step S1, at 8% (w/w).

\textcircled{4} step S4 of culturing and fermenting the aloe natural medium inoculated with the Cordyceps militaris spores: The aloe natural medium inoculated with the Cordyceps militaris spores in step S3 is cultured and fermented at the optimum conditions (at a temperature of 25° C. and a shaking rate 115 rpm) for 8 days.

\textcircled{5} step S5 of recovering a fermentation product of aloe: The fermentation product of aloe, the culture of which is completed in step S4, is recovered as shown in FIG. 4.

### Exemplary Embodiment 8

A method of manufacturing a fermentation product of aloe by using Hericeum erinaceum as spores (pre-culture fluid), the method comprises:

\textcircled{1} step S1 of preparing an aloe natural medium using dried aloe: This step is to prepare the natural medium by mixing the dried aloe and purified water. The pure aloe natural medium is prepared by placing a mixture of 3% dried aloe and 97% purified water, another mixture of 5% dried aloe and 95% purified water, and another mixture of 7% dried aloe and 93% purified water into fermentation culture tanks, respectively, mixing the mixtures, applying heat to the mixtures to be sterilized at 113˜125° C. for 2˜30 minutes, and cooling (quenching) the mixtures to 20˜25° C.

\textcircled{2} step S2 of preparing Hericeum erinaceum spores: To use Hericeum erinaceum fungi as the spores (pre-culture fluid), the spores (pre-culture fluid) are prepared by culturing the Hericeum erinaceum fungi at a temperature of 25° C. and a shaking rate of 125 rpm, for 5 days.

\textcircled{3} step S3 of inoculating the Hericeum erinaceum spores: The Hericeum erinaceum pre-culture fluid (spores) prepared in step S2 are inoculated into the aloe natural medium prepared in step S1, at 8% (w/w).

\textcircled{4} step S4 of culturing and fermenting the aloe natural medium inoculated with the Hericeum erinaceum spores: The aloe natural medium inoculated with the Hericeum erinaceum spores in step S3 is cultured and fermented at the optimum conditions (at a temperature of 25° C. and a shaking rate 125 rpm) for 8 days.

\textcircled{5} step S5 of recovering a fermentation product of aloe: The fermentation product of aloe, the culture of which is completed in step S4, is recovered.

### Exemplary Embodiment 9

As a method of manufacturing a final product using the fermentation product of aloe (i.e., a method of using the fermentation product of aloe as a drink), after each of the fermentation products obtained in Exemplary Embodiments 1˜8 is sterilized, each fermentation product being pure without any other additives is contained in a container, to be the final product. The container for the final product is appropriately 250 ml, 500 ml or 1000 ml in volume.

### Exemplary Embodiment 10

As a method of manufacturing a final product using the fermentation product of aloe (i.e., a method of using the fermentation product of aloe as a drink), after each of the fermentation products obtained in exemplary embodiments 1˜8 is sterilized and freeze-dried, each fermentation product is used as a material in making the final product in the form of powder or tablets.

Sensory Evaluation of Fermentation Product of Aloe

Sensory evaluation is conducted with respect to natural aloe, the fermentation product of aloe obtained by culturing each of Ganoderma lucidum, Phellinus linteus and Cordyceps militaris in the natural medium prepared by using the aloe leaves as described in Exemplary Embodiments 1˜4, and the fermentation product of aloe obtained by culturing each of Ganoderma lucidum, Phellinus linteus and Cordyceps militaris in the natural medium prepared by using the dried aloe as described in Exemplary Embodiments 5˜8. Participation panel consists of six people engaging in the study of aloe for one or more years. The highest evaluation score (each of taste, flavor and overall acceptance) is 5. The results are shown in Table 1.

TABLE 1

| | Sensory Evaluation | | | |
|---|---|---|---|---|
| | | | Overall | |
| Classification | Taste | Flavor | Acceptance | Remark |
| Natural aloe | 1.50/5.00 | 1.50/5.00 | 1.50/5.00 | [symbol] |
| Exemplary | 3.35/5.00 | 3.17/5.00 | 3.33/5.00 | [symbol] |
| Embodiment 1 | | | | |
| Exemplary | 3.00/5.00 | 3.00/5.00 | 3.00/5.00 | [symbol] |
| Embodiment 2 | | | | |
| Exemplary | 3.17/5.00 | 3.17/5.00 | 3.17/5.00 | [symbol] |
| Embodiment 3 | | | | |
| Exemplary | 3.17/5.00 | 3.17/5.00 | 3.17/5.00 | [symbol] |
| Embodiment 4 | | | | |
| Exemplary | 3.50/5.00 | 3.00/5.00 | 3.25/5.00 | [symbol] |
| Embodiment 5 | | | | |
| Exemplary | 3.00/5.00 | 3.00/5.00 | 3.00/5.00 | [symbol] |
| Embodiment 6 | | | | |
| Exemplary | 3.00/5.00 | 3.00/5.00 | 3.00/5.00 | [symbol] |
| Embodiment 7 | | | | |
| Exemplary | 3.50/5.00 | 3.00/5.00 | 3.25/5.00 | [symbol] |
| Embodiment 8 | | | | |

Review of Functionality of Fermentation Product of Aloe (Effect of Improvement of Stomach Function)

1) Anti-Microbial (I) Against Helicobacter pylori Bacterium: Test Using a Disk Method:

For the effects against Helicobacter pylori known as a bacterium causing the gastric diseases, a paper disk test has been conducted by comparing the fermentation products of aloe <the fermentation product of Ganoderma lucidum (AG) and the fermentation product of Hericium erinaceum (AH)> which are obtained from the aloe natural medium prepared by using the aloe leaves as described in Exemplary Embodiments 1 and 4, the fermentation products of aloe <the fermentation product of Ganoderma lucidum (DAG) and the fermentation product of Hericium erinaceum (DAH)> which are obtained from the aloe natural medium prepared by using the dried aloe as described in Exemplary Embodiments 5 and 8, and natural aloe (A).

H. pylori cultured in the Brucella medium at 37° C. for 3 days is suspended to reach 108˜109 cfu/ml. The suspended bacteria are again smeared in the Brucella agar medium. Then, a paper disk is placed thereon.

A sample diluted to 1 mg/ml is absorbed on the paper disk. After the plates are cultured under the microaerophilic conditions at 37° C. for 3 days, an inhibition zone shown around each plate is measured (at the radius except for the paper disk). The results are shown in Table 2.

TABLE 2

| | Growth Inhibition Effects | | |
|---|---|---|---|
| | Against Helicobacter pylori | | |
| Classification | (inhibition zone) | | Remarks |
| Natural aloe (A) | 2~3 | mm | [symbol] |
| fermentation product of | 5~6 | mm | [symbol] |
| Ganoderma lucidum (AG) | | | |
| fermentation product of | 6~7 | mm | [symbol] |
| Hericium erinaceum (AH) | | | |
| fermentation product of | 5.2~5.7 | mm | [symbol] |
| Ganoderma lucidum (DAG) | | | |
| fermentation product of | 6.1~6.6 | mm | [symbol] |
| Hericium erinaceum (DAH | | | |

2) Anti-Microbial (II) Against Helicobacter pylori Bacterium: Urease Activity Inhibition Test:

7 ml Urease Assay medium (Bacto Yeast extract 0.1 g, potassium phosphate monobasic 9.1 g, potassium phosphate dibasic 9.5 g, urea 20 g, phenol red 0.01 g, DW 1 L, and pH 6.8) is placed in a cell culture tube. 5×10⁴H. pylori is poured in each cell culture tube. After pouring H. pylori, the concentration of each sample is processed to be 250 μg/ml and cultured in an incubator under the following conditions: temperature 37° C., humidity: 10%, 5% and 100%. After that, absorbance is measured at 550 nm, by using a spectrophotometer, at the intervals of 24 hours, 48 hours and 72 hours. By considering the absorbance of the culture tube culturing only H. pylori as 100%, the absorbance of each test sample is compared with that of the culture tube culturing only H. pylori and an evaluation is based on a relative value. Since the sample itself tends to absorb light at 550 nm, the absorbance in the concentration (250 μg/ml) of processing H. pylori is measured and compensated. The results are shown in Table 3.

TABLE 3

| | Urease Activity (%) | | |
|---|---|---|---|
| Classification | 24 hr | 48 hr | 72 hr |
| Control | 100 | 100 | 100 |
| fermentation product of | 42 | 48 | 76 |
| Ganoderma lucidum (AG) | | | |
| fermentation product of | 82 | 8 | 7 |
| Hericium erinaceum (AH) | | | |
| fermentation product of | 42 | 9 | 8 |
| Phellinus linteus (AP) | | | |

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of manufacturing a fermentation product of aloe, comprising:
a preparation step (S1) of preparing an aloe natural medium using aloe;
a mushroom spore preparation step (S2) of preparing mushroom spores to be cultured in the aloe natural medium;
an inoculation step (S3) of inoculating the mushroom spores into the aloe natural medium as prepared in the preparation step (S1);
a culture/fermentation step (S4) of culturing and fermenting the aloe natural medium inoculated with the mushroom spores in the inoculation step (S3) at a temperature of 24˜34° C. for 3˜10 days.

2. The method according to claim 1, wherein the preparation step (S1) prepares the aloe natural medium by using fresh aloe leaves or dried aloe.

3. The method according to claim 2, wherein the preparation step (S1) of preparing the aloe natural medium by using the fresh aloe leaves comprises the steps of:
obtaining a viscous gel by processing the aloe leaves by the steps of collection-cleaning-peeling-pulverization;
placing only the viscous gel as obtained or a mixture of the viscous gel of 25˜99 wt % and purified water of 1˜75 wt % into a fermentation culture tank, and heating the viscous gel or the mixture to be sterilized at 113˜125° C. for 2˜30 minutes; and
quenching the viscous gel or the mixture to 20˜25° C.

4. The method according to claim 2, wherein the preparation step (S1) of preparing the aloe natural medium by using the dried aloe comprises the steps of:
mixing the dried aloe of 0.5˜7.0 wt % and purified water of 93.0˜99.5 wt %;
placing a mixture of the dried aloe and purified water into a fermentation culture tank and mixing the mixture;
heating the mixture to be sterilized at 113˜125° C. for 2˜30 minutes; and
quenching the mixture to 20˜25° C.

5. The method according to claim 1, wherein the mushroom spores as inoculated in the inoculation step (S3) are cultured at a temperature of 24˜34° C. and at a ventilation rate of 0.3˜0.8 vvvm, for 4˜8 days, to be used.

6. The method according to claim 1, wherein the mushroom spores as inoculated in the inoculation step (S3) are inoculated into the aloe natural medium at 5˜15% (w/w).

7. The method according to claim 1, wherein the mushroom spores inoculated in the inoculation step (S3) are only one kind selected from a group consisting of Ganoderma lucidum, Phellinus linteus, Cordyceps militaris, Paecilomyces japonica, Hericium erinaceum and Agaricus blazei.

8. A fermentation product of aloe manufactured by the method according to claim 1 or claim 7.

9. A freeze-dried fermentation product of aloe manufactured by the method according to claim 1 or claim 7.

10. Functional foods using a fermentation product of aloe manufactured by the method according to claim 1 or claim 7.

11. Functional foods including a main ingredient using a fermentation product of aloe manufactured by the method according to claim 1 or claim 7.
